(19) United States
(12) Patent Application Publication
(10) Pub. No.: US 2007/0242676 A1
(43) Pub. Date: Oct. 18, 2007

(54) INTERFACE BETWEEN A SYNCHRONOUS NETWORK AND HIGH-SPEED ETHERNET

(75) Inventor: Amit Fridman, Yehud (IL)

Correspondence Address: DARBY & DARBY P.C., P.O. BOX 770, Church Street Station, New York, NY, 10008-0770, US

(73) Assignee: CORRIGENT SYSTEMS LTD., Tel Aviv (IL)

(21) Appl. No.: 11/279,710

(22) Filed: Apr. 13, 2006

(51) Int. Cl. H04L 12/56

(52) U.S. Cl. 370/395.5; 370/466

(57) ABSTRACT

A method for communication includes receiving over a synchronous optical network link a flow of encapsulated Ethernet data frames. Two or more of the Ethernet data frames are concatenated to form an extended frame having a single start frame delimiter (SFD) and a single end frame delimiter (EFD) in compliance with an Ethernet standard, and the extended frame is transmitted over an Ethernet link.

### FIELD OF THE INVENTION

The present invention relates generally to data communications, and specifically to methods and systems for transferring packet communication traffic between TDM and packet networks.

### BACKGROUND OF THE INVENTION

### Definitions

In the context of the present patent application and in the claims, the terms listed below shall be interpreted as follows:
A synchronous optical network is a network operating in accordance with either SONET (Synchronous Optical Network) or SDH (Synchronous Digital Hierarchy) standards. These standards define a hierarchical set of transmission rates and transmission formats for carrying high-speed, time-domain-multiplexed (TDM) digital signals.
An Ethernet network is a packet network operating in accordance with the IEEE 802.3 set of standards, which define a protocol and frame format for data communication. The terms “packet” and “frame” are used herein interchangeably.
10 Gigabit Ethernet (10 GbE) is a type of Ethernet network that operates at a nominal speed to 10 Gb/s. This type of network uses the medium access control (MAC) protocol sublayer defined by IEEE 802.3, connected through a 10 Gigabit Media Independent Interface (XGMII) to a suitable 10 Gb/s physical layer interface (PHY). XGMII is specified in Clause 46 of IEEE Standard 802.3ae™ (Institute of Electrical and Electronics Engineers, New York, N.Y., 2002), which is incorporated herein by reference.

### DESCRIPTION OF RELATED ART

The Synchronous Optical Network (SONET) is a set of standards that define a hierarchical set of transmission rates and transmission formats for carrying high-speed, time-domain-multiplexed (TDM) digital signals. SONET lines commonly serve as trunks for carrying traffic between circuits of the plesiochronous digital hierarchy (PDH) used in circuit-switched communication networks. SONET standards of relevance to the present patent application are described, for example, in Synchronous Optical Network (SONET) Transport Systems: Common Generic Criteria (Telcordia Technologies, Piscataway, N.J., publication GR-253-CORE, September, 2000), which is incorporated herein by reference. While the SONET standards have been adopted in North America, a parallel set of standards, known as Synchronous Digital Hierarchy (SDH), has been promulgated by the International Telecommunications Union (ITU), and is widely used in Europe. From the point of view of the present invention, however, these alternative standards are functionally interchangeable.

The lowest-rate link in the SONET hierarchy is the OC-1 level, which is capable of carrying 8000 STS-1 frames per second, at a line rate of 51.840 Mb/s. Higher-speed links in the hierarchy, referred to as OC-N links, operate at rates that are multiples of the basic 51.840 Mbps OC-1 rate. For example, OC-192 supports a line rate of 9953.28 Mb/s. (The term OC-192 as used herein should be understood as covering all types of data paths that may be carried at the OC-192 line rate, including both multiplexed STS-1 paths and concatenated paths, which are sometimes referred to as OC-192c.) This line rate is similarly supported by the SDH STM-64 link.

The Generic Framing Procedure (GFP) has been developed to enable efficient encapsulation and transport of packet traffic, such as Ethernet frames, over synchronous optical networks. GFP is defined in ITU-T Recommendation G.7041/Y.1303, promulgated by the International Telecommunications Union (available at www.itu.int/itudoc/itu-t/aap/sg15aap/history/g.7041/index.html), which is incorporated herein by reference. In frame-mapped GFP (GFP-F, defined in Clause 7 of the Recommendation), each Ethernet data frame, from MAC header through frame check sequence (FCS) is encapsulated in a single, corresponding GFP frame with GFP core and payload headers. The core header is four bytes long, and the payload header may also be four bytes or longer, depending on whether an optional extension header is included. GFP drops the non-data-carrying portions of the Ethernet data stream, including the inter-frame gap (IFG), frame preamble, start frame delimiter (SFD) and end frame delimiter (EFD). The GFP frames are then concatenated in the SONET or SDH frame payload.

### SUMMARY OF THE INVENTION

From the foregoing description, it can be appreciated that GFP provides efficient bandwidth utilization, since it can transport Ethernet frames with only eight bytes of header overhead per frame, while eliminating the non-data portions of the Ethernet data stream. As a result, the GFP-encapsulated stream of Ethernet frames may actually contain less overhead than the original Ethernet stream that it encapsulates.

This discrepancy can be problematic when the stream of frames is transported over the synchronous optical network at high-speed (>9.5 Gb/s) and is to be converted back to individual Ethernet frames on a corresponding high-speed Ethernet link. As will be demonstrated in greater detail hereinbelow, when an OC-192 link with GFP, for example, is coupled to deliver a stream of short Ethernet frames to a 10 GbE XGMII Ethernet interface, the Ethernet link will be unable to keep up with the GFP data rate. This result is surprising, since the nominal data rate of the Ethernet link (10 Gb/s) is higher than that of OCS-192 (9.95328 Gb/s), and stems from the high efficiency of the GFP encapsulation.

In embodiments of the present invention, a GFP/Ethernet interface MAC adapter overcomes this discrepancy by concatenating the Ethernet frames following GFP de-encapsulation to form an extended frame. The extended frame has a single start frame delimiter (SFD) and a single end frame delimiter (EFD) in compliance with Ethernet standards and thus appears on the Ethernet network to be a single, longer Ethernet frame. The extended frame is preceded by only a single IFG and preamble, so that the overhead per frame on the Ethernet link is reduced considerably relative to transmission of separate, individual Ethernet data frames. As a result, the Ethernet interface is able to keep pace with the incoming GFP stream. Typically, another compatible MAC adapter at a node downstream from the GFP/Ethernet interface breaks the extended frames into their component individual Ethernet data frames for delivery to the respective destination addresses or, alternatively, for re-encapsulation in GFP frames for transport over another synchronous optical link.

Although the embodiments described herein refer to certain specific link types and data rates, the principles of the present invention may similarly be applied in interfacing between other types of high-speed synchronous and packet network links.

There is therefore provided, in accordance with an embodiment of the present invention, a method for communication, including:
receiving over a synchronous optical network link a flow of encapsulated Ethernet data frames;
concatenating two or more of the Ethernet data frames to form an extended frame having a single start frame delimiter (SFD) and a single end frame delimiter (EFD) in compliance with an Ethernet standard; and
transmitting the extended frame over an Ethernet link.

Typically, the two or more of the Ethernet data frames include respective headers and data payloads, and the extended frame includes the headers and data payloads of all of the two or more of the Ethernet data frames. In a disclosed embodiment, concatenating the two or more of the Ethernet data frames includes inserting a predetermined separator sequence between the Ethernet data frames in the extended frame. The method may also include receiving the extended frame over the Ethernet link, and separating the Ethernet data frames out of the extended frame responsively to the separator sequence.

In some embodiments, receiving the flow of encapsulated Ethernet data frames includes receiving the flow at a data rate greater than 9.5 Gb/s, and transmitting the extended frame includes transmitting the extended frame over a 10 Gb/s Ethernet (10 GbE) link. In one embodiment, the Ethernet data frames are encapsulated for transmission over the synchronous optical network link using a Generic Framing Procedure (GFP).

There is also provided, in accordance with an embodiment of the present invention, a method for communication, including:
receiving over a synchronous optical network link at a rate in excess of 9.5 Gb/s a flow of Ethernet data frames encapsulated using a Generic Framing Procedure (GFP); and
transmitting the flow of the Ethernet data frames over a 10 Gb/s Ethernet (10 GbE) link.

Typically, the synchronous optical network link includes at least one of a SONET OC-192 link and a SDH STM-64 link, and transmitting the flow includes transmitting all of the Ethernet data frames over the 10 GbE link without frame loss irrespective of a size of the Ethernet data frames.

There is additionally provided, in accordance with an embodiment of the present invention, apparatus for communication, including:
a receiver, which is arranged to receive over a synchronous optical network link a flow of encapsulated Ethernet data frames;
an adapter, which is coupled to concatenate two or more of the Ethernet data frames to form an extended frame having a single start frame delimiter (SFD) and a single end frame delimiter (EFD) in compliance with an Ethernet standard; and
a transmitter, which is arranged to transmit the extended frame over an Ethernet link.

In a disclosed embodiment, the adapter includes a buffer, which is coupled to receive the Ethernet data frames from the receiver, and a transmit controller, which is coupled to initiate concatenation of the Ethernet data frames to form the extended frame when a fill level of the buffer exceeds a predetermined watermark. Additionally or alternatively, the adapter includes a counter, which is coupled to count a number of bytes placed in the extended data frame, and to terminate concatenation of the Ethernet data frames when the number reaches a predetermined limit.

There is further provided, in accordance with an embodiment of the present invention, apparatus for communication, including:
a receiver, which is arranged to receive over a synchronous optical network link at a rate in excess of 9.5 Gb/s a flow of Ethernet data frames encapsulated using a Generic Framing Procedure (GFP);
an adapter, which is coupled to de-encapsulate and process the Ethernet data frames; and
a transmitter, which is arranged to receive the Ethernet data frames from the adapter and to transmit the flow over a 10 Gb/s Ethernet (10 GbE) link.

There is moreover provided, in accordance with an embodiment of the present invention, a network node, including:
first and second ring network interfaces, which are arranged to transmit and receive data over respective synchronous optical network links in a ring network at a rate in excess of 9.5 Gb/s; and
a 10 Gb/s Ethernet (10 GbE) link for transfer of the data between the first and second ring network interfaces.

In a disclosed embodiment, the data include a flow of Ethernet data frames encapsulated using a Generic Framing Procedure (GFP).

The present invention will be more fully understood from the following detailed description of the embodiments thereof, taken together with the drawings in which:

### BRIEF DESCRIPTION OF THE DRAWINGS

FIG. 1 is a block diagram that schematically illustrates a communication network system, in accordance with an embodiment of the present invention;

FIG. 2 is a block diagram that schematically illustrates a network interface, in accordance with an embodiment of the present invention;

FIG. 3 is a block diagram that schematically illustrates GFP encapsulation of Ethernet frames;

FIG. 4 is a block diagram that schematically illustrates an Ethernet frame generator, in accordance with an embodiment of the present invention;

FIG. 5 is a block diagram that schematically illustrates an extended frame, in accordance with an embodiment of the present invention; and

FIG. 6 is a block diagram that schematically illustrates an Ethernet frame receiver, in accordance with an embodiment of the present invention.

### DETAILED DESCRIPTION OF EMBODIMENTS

FIG. 1 is a block diagram that schematically illustrates a communication network system 20, in accordance with an embodiment of the present invention. System 20 in this example comprises a ring network 22 and a packet network 24. The ring network operates as a synchronous optical network in accordance with the SONET or SDH standard at the OC-192 (STM-64) line rate. The packet network is an Ethernet network. Networks 22 and 24 are connected by a 10 Gb/s Ethernet (10 GbE) link 26 between nodes 28 and 30.

Node 28 comprises “east” and “west” synchronous optical network interfaces 32 and 34, which connect to ring network 22 in accordance with the applicable synchronous optical network standard. (The terms “east” and “west” are used here solely for the sake of convenience and have no geographical meaning.) In an exemplary embodiment, network 22 is a bi-directional network, such as a Resilient Packet Ring (RPR) network, but the principles of this embodiment are applicable in connection to any sort of synchronous optical network link operating at the OC-192 rate.

Nodes 28 and 30 comprise suitable 10 GbE interfaces 36 and 38, for example, XGMII-compliant interfaces, as described in the above-mentioned IEEE 802.3ae standard. Optionally, each of interfaces 36 and 38 comprises a 10 Gigabit Attachment Unit Interface (XAUI), to extend the operational distance of the XGMII and to reduce the number of interface signals, as described in Clause 47 of IEEE 802.3ae. XGMII and XAUI interfaces may also be used for exchanging data at high speed within node 28, such as between east and west synchronous optical network interfaces 32 and 34 and/or between these interfaces and interface 36.

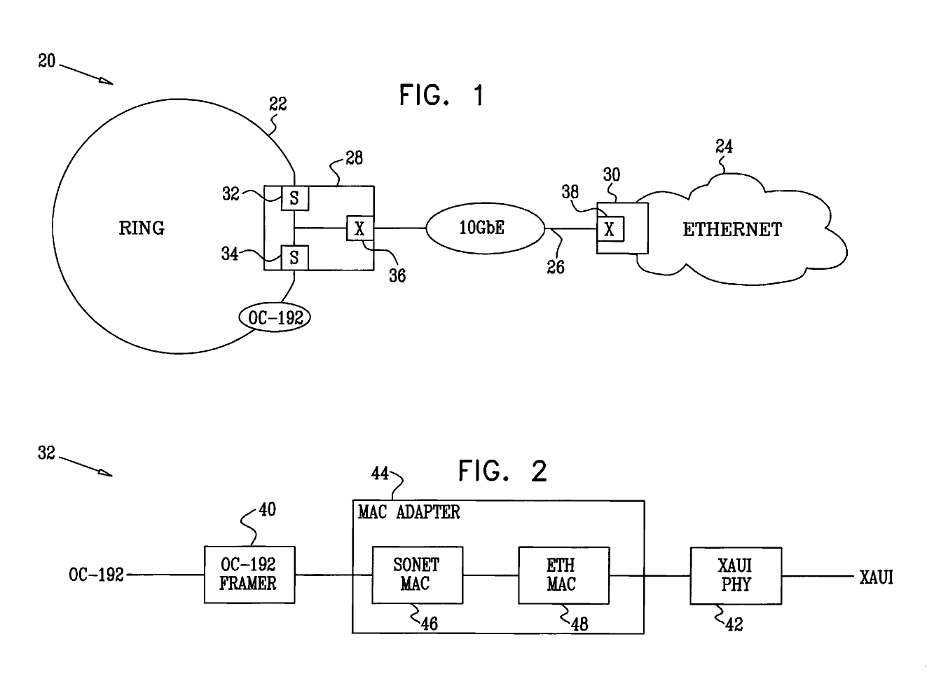

FIG. 2 is a block diagram that schematically shows details of interface 32, in accordance with an embodiment of the present invention. Interface 34 may be similarly constructed. In this embodiment, interface 32 connects to network 22 via an OC-192 framer 40, and connects internally to interface 34 and/or interface 36 via a 10 GbE XAUI PHY 42. Framer 40 and PHY 42 serve as transmitters and receivers of frames on the corresponding networks. The payloads of the SONET frames transmitted and received by framer 40 on network 22 are assumed to comprise GFP-encapsulated Ethernet frames. XAUI PHY 42 transmits and receives the Ethernet frames in accordance with the applicable Ethernet protocols, without the GFP framing. Framer 40 and PHY 42 may be standard off-shelf components, such as the PM5392 OC-192 network interface and the PM8358 XAUI PHY, made by PMC-Sierra (Santa Clara, Calif.).

A MAC adapter 44 between framer 40 and PHY 42 performs encapsulation and de-encapsulation functions, as described hereinbelow. Typically, the MAC adapter communicates with framer 40 and PHY 42 using standard protocol interfaces, such as System Packet Interface Level 4, Phase 2 (SPI4.2) and XGMII interfaces, respectively. In order to meet the high processing speed requirements of interface 32, MAC adapter 44 typically comprises one or more application-specific integrated circuit (ASIC) devices and/or field programmable gate arrays (FPGA). Alternatively, at least some of the functions of the MAC adapter may be implemented in software on a suitable microprocessor.

MAC adapter 44 comprises a SONET MAC processor 46 terminates and removes the GFP headers of frames received from network 22, and adds the appropriate GFP headers to frames for transmission over network 22. These SONET MAC functions are performed in the conventional manner, as mandated by the above-mentioned G.7041 recommendation, and the implementation of processor 46 will thus be apparent to those skilled in the art. An Ethernet MAC processor 48 receives the de-encapsulated Ethernet frames from processor 46, and prepares the frames for transmission by XAUI PHY 42. Processor 48 likewise prepares Ethernet frames received from XAUI PHY 42 for GFP encapsulation. Processor 48 is responsible for maintaining rate compatibility between the OC-192 and 10 GbE sides of interface 32, as will be explained in detail hereinbelow.

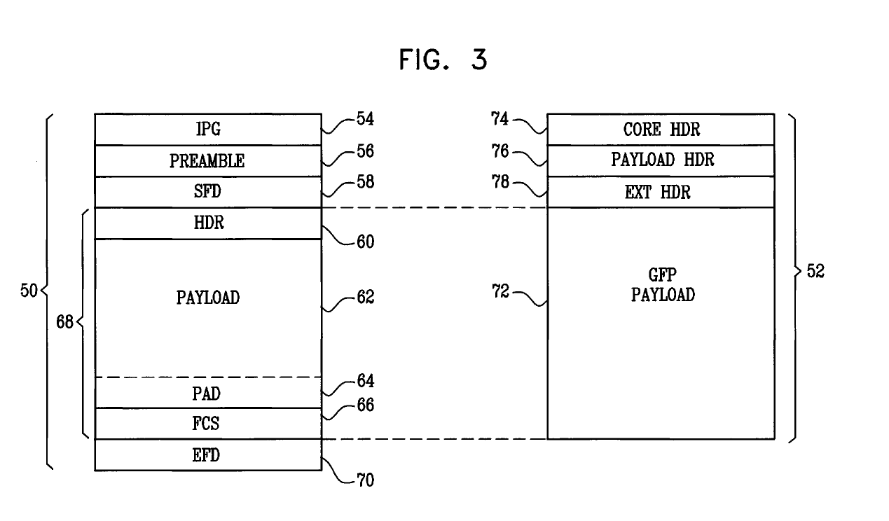

FIG. 3 is a block diagram that schematically illustrates aspects of encapsulation of an Ethernet data frame 68 in a GFP frame 52. This figure is presented as an aid in understanding the motivation for and implementation of an embodiment of the present invention. Ethernet data frame 68, as specified by the IEEE 802.3 and 802.3ae standards, is carried in a data stream that comprises, for each frame, an inter-packet gap (IPG) 54 (twelve bytes on average), preamble (seven bytes), start-of-frame delimiter (SFD) 58 (one byte), and end-of-frame delimiter (EFD) 70 (one byte). In other words, each data frame requires, on average, twenty-one bytes of overhead. The data frame itself comprises a MAC header 60, data payload 62, padding bits 64 as required, and a frame check sequence 66. The shortest permissible Ethernet data frame is sixty-four bytes long.

Data frame 68 is encapsulated as a payload 72 of GFP frame 52. GFP adds a core header 74 (four bytes) and a payload header 76 (four bytes), and optionally an extension header 78 and a frame check sequence (FCS—not shown). Thus, when the extension header is not used, GFP adds only eight bytes of overhead to each Ethernet data frame, in contrast to the twenty-one bytes added in the Ethernet data stream. Assuming minimal-size Ethernet data frames of sixty-four bytes each, the OC-192 link operating at 9.58464 Gb/s is then capable of transmitting 16,640,000 frames/second.

By contrast, even at the nominal rate of 10 Gb/s, the Ethernet link will be capable of transmitting only about 14,705,883 frames/second, because of the higher overhead on the Ethernet link. MAC adapter 44 must be capable of dealing with the frame rate mismatch between the OC-192 and XMGII interfaces in order to avoid losing packets under high load conditions. Methods for dealing with the mismatch are described hereinbelow.

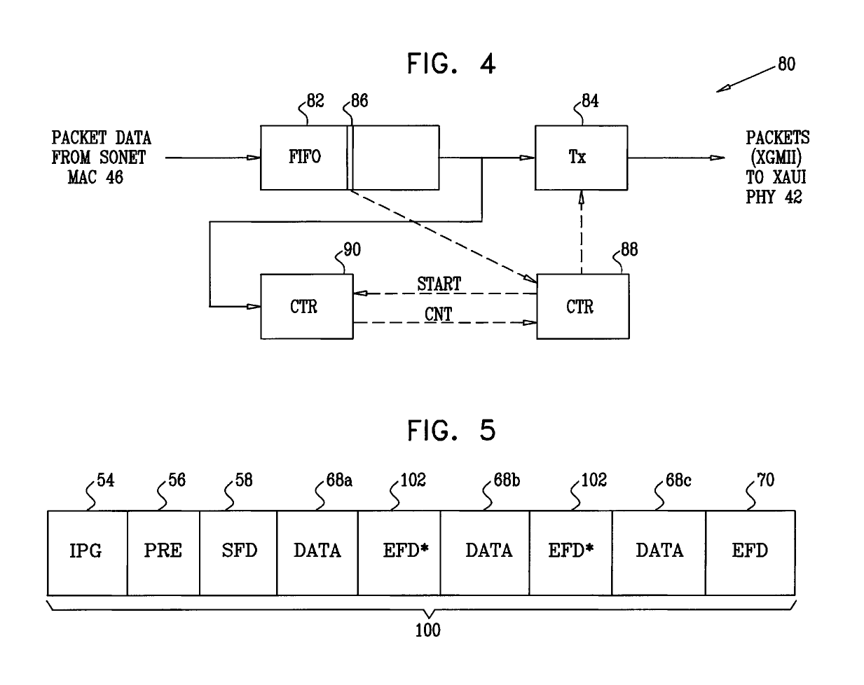

FIG. 4 is a block diagram that schematically illustrates an Ethernet frame generator 80, in accordance with an embodiment of the present invention. Generator 80 may be used, for example, as part of Ethernet MAC processor 48 (FIG. 2), for processing Ethernet frames that have been received from OC-192 framer 40, after removal of GFP encapsulation by SONET MAC processor 46. The object of frame generator 80 is to concatenate the incoming frames into extended frames, which still comply with the XMGII protocol but spread the overhead of the Ethernet data stream over several frames.

De-encapsulated Ethernet data frames 68 (FIG. 3) enter a first-in-first-out (FIFO) buffer 82 of frame generator 80. A transmitter 84 reads the frames out of the buffer and adds the conventional XGMII overhead of IFG 54, preamble 56, SFD 58, and EFD 70 before transmitting the data stream to PHY 42. As long as buffer 82 remains relatively empty, transmitter 84 transmits one output frame for each Ethernet data frame that enters the buffer. When the buffer fill level passes a predetermined watermark 86, however, a transmit controller 88 instructs transmitter 84 to begin concatenating packets into extended frames in order to empty buffer 82 more rapidly. Generation of extended frames generally continues until the buffer fill level has dropped back below the watermark.

FIG. 5 is a block diagram that schematically illustrates an extended frame 100, in accordance with an embodiment of the present invention. The extended frame comprises multiple Ethernet data frames 68a, 68b, 68c, . . . , which are separated by a predefined separator sequence 102, labeled EFD*. Each Ethernet data frame in the extended frame comprises the original header, payload data, fill bits and FCS. The separator sequence may comprise any short sequence of bytes that will be recognized as a separator by a suitably-programmed XGMII receiver but will appear to other 10 GbE components to be simply another symbol in the frame payload. For example, the separator sequence may comprise a reserved XGMII code, as listed in Table 46-3 in the above-mentioned 802.3ae standard (such as the reserved code 0xDC with the TXC control bit set). For convenience, the separator code may be padded with idle codes to complete a four-byte sequence.

Transmitter 84 adds the appropriate IFG 54, preamble 56 and SFD 58 at the beginning of extended frame 100, and appends EFD 70 at the end. Thus, when the extended frame is transmitted over a 10 GbE link, it will appear to be a conventional Ethernet frame, meeting all the applicable requirements. In this example, the overhead per Ethernet data frame is reduced to ten bytes, so that transmitter 84 will be capable of transmitting 16,891,891 frames/second and will thus keep pace with the incoming GFP-encapsulated stream of data frames. Although extended frame 100 is shown in FIG. 5 as comprising only three Ethernet data frames, in practice a larger number of data frames may be concatenated in a single extended frame.

Since the IPG byte sequence is used by the XAUI receiver to compensate for clock differences relative to the XAUI transmitter, the length of extended frame 100 is limited by the possible clock mismatch between the transmitter and the receiver. (The receiver compensates for the mismatch by skipping four bytes in the IPG sequence, as is known in the art. It can be shown that for clock variability of ±100 ppm, the extended frame should therefore be no longer than 20 kbytes.) Furthermore, the length of the extended frame may be limited by the maximum frame size permitted in the 10 GbE network over which the extended frames are to be transmitted.

Therefore (returning to FIG. 4), when transmit controller 88 instructs transmitter 84 to begin constructing an extended frame, the transmit controller simultaneously actuates a byte counter 90. The transmit controller will then instruct the transmitter to terminate and transmit the extended frame either when the fill level of buffer 82 has dropped below watermark 86 or when byte counter 90 reports that the number of bytes in the extended frame has reached a preset maximum value, as determined by the timing or frame size limitations described above. Depending on the buffer fill level, the transmit controller will then instruct the transmitter either to construct another extended frame or to transmit the next data frame without concatenation.

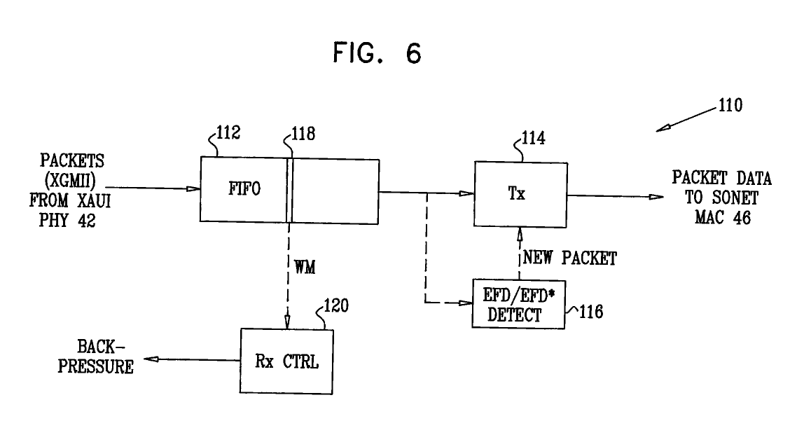

FIG. 6 is a block diagram that schematically illustrates an Ethernet extended frame receiver 110, in accordance with an embodiment of the present invention. Receiver 110 may be incorporated, for example, along with frame generator 80, in Ethernet MAC processor 48 (FIG. 2) for processing an incoming Ethernet data stream that has been received over a 10 GbE link by PHY 42. The incoming Ethernet data stream may comprise extended frames, as shown in FIG. 5 and described above.

The incoming data stream from PHY 42 is placed in a FIFO buffer 112. An Ethernet data frame transmitter 114 removes the non-data portion of the stream and passes data frames 68 (FIG. 3) to SONET MAC processor 46 for GFP encapsulation. An end-frame detector 116 detects both EFD 70 and separator sequence (EFD*) 102 in the byte stream from buffer 112, and instructs transmitter 114 to send an appropriate end-frame control to the SONET MAC processor in either case.

When large Ethernet data frames are transmitted over the 10 GbE link to PHY 42 at the nominal 10 Gb/s speed, the data rate may exceed the capability of the SONET OC-192 interface, which is limited to 9.58464 Gb/s. In order to avoid buffer overflow due to this eventuality, a receive controller 120 senses when the fill level of buffer 112 exceeds a preset watermark 118. The receive controller then sends a back-pressure signal to the transmitting MAC processor, which will cause the transmitter to reduce its transmission rate in accordance with Ethernet convention.

Receiver 110 may alternatively be part of an Ethernet bridge or other switch, at node 30 (FIG. 1), for example. In this case, after the receiver breaks the extended frames into individual Ethernet data frames, the bridge will forward the individual Ethernet data frames to the respective destination MAC addresses in the normal manner. Other applications of transmitter 80 and receiver 110 in rate adaptation between OC-192 and 10 GbE networks will be apparent to those skilled in the art.

Furthermore, although system 20 and the methods described above in the context of this system relate specifically to OC-192 and 10 GbE, the principles of the present invention will similarly be applicable in interfacing between other types of high-speed synchronous and packet network links as network speeds continue to grow in excess of 10 Gb/s. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for communication, comprising:
receiving over a synchronous optical network link a flow of encapsulated Ethernet data frames;
concatenating two or more of the Ethernet data frames to form an extended frame having a single start frame delimiter (SFD) and a single end frame delimiter (EFD) in compliance with an Ethernet standard; and
transmitting the extended frame over an Ethernet link.

2. The method according to claim 1, wherein the two or more of the Ethernet data frames comprise respective headers and data payloads, and wherein the extended frame comprises the headers and data payloads of all of the two or more of the Ethernet data frames.

3. The method according to claim 2, wherein concatenating the two or more of the Ethernet data frames comprises inserting a predetermined separator sequence between the Ethernet data frames in the extended frame.

4. The method according to claim 3, and comprising receiving the extended frame over the Ethernet link, and separating the Ethernet data frames out of the extended frame responsively to the separator sequence.

5. The method according to claim 1, wherein receiving the flow of encapsulated Ethernet data frames comprises receiving the flow at a data rate greater than 9.5 Gb/s, and wherein transmitting the extended frame comprises transmitting the extended frame over a 10 Gb/s Ethernet (10 GbE) link.

6. The method according to claim 5, wherein the Ethernet data frames are encapsulated for transmission over the synchronous optical network link using a Generic Framing Procedure (GFP).

7. The method according to claim 1, wherein receiving the flow of encapsulated Ethernet data frames comprises placing the Ethernet data frames in a buffer, and wherein concatenating the two or more of the Ethernet data frames comprises forming the extended frame when a fill level of the buffer exceeds a predetermined watermark.

8. The method according to claim 1, wherein concatenating the two or more of the Ethernet data frames comprises counting a number of bytes placed in the extended data frame, and terminating concatenation when the number reaches a predetermined limit.

9. A method for communication, comprising:
receiving over a synchronous optical network link at a rate in excess of 9.5 Gb/s a flow of Ethernet data frames encapsulated using a Generic Framing Procedure (GFP); and
transmitting the flow of the Ethernet data frames over a 10 Gb/s Ethernet (10 GbE) link.

10. The method according to claim 9, wherein the synchronous optical network link comprises at least one of a SONET OC-192 link and a SDH STM-64 link.

11. The method according to claim 9, wherein transmitting the flow comprises transmitting all of the Ethernet data frames over the 10 GbE link without frame loss irrespective of a size of the Ethernet data frames.

12. Apparatus for communication, comprising:
a receiver, which is arranged to receive over a synchronous optical network link a flow of encapsulated Ethernet data frames;
an adapter, which is coupled to concatenate two or more of the Ethernet data frames to form an extended frame having a single start frame delimiter (SFD) and a single end frame delimiter (EFD) in compliance with an Ethernet standard; and
a transmitter, which is arranged to transmit the extended frame over an Ethernet link.

13. The apparatus according to claim 12, wherein the two or more of the Ethernet data frames comprise respective headers and data payloads, and wherein the extended frame comprises the headers and data payloads of all of the two or more of the Ethernet data frames.

14. The apparatus according to claim 13, wherein the adapter is operative to insert a predetermined separator sequence between the Ethernet data frames in the extended frame.

15. The apparatus according to claim 14, and a receiving device, which is arranged to receive the extended frame over the Ethernet link and to separate the Ethernet data frames out of the extended frame responsively to the separator sequence.

16. The apparatus according to claim 12, wherein the receiver is configured to receive the flow at a data rate greater than 9.5 Gb/s, and wherein the transmitter is configured to transmit the extended frame over a 10 Gb/s Ethernet (10 GbE) link.

17. The apparatus according to claim 16, wherein the Ethernet data frames are encapsulated for transmission over the synchronous optical network link using a Generic Framing Procedure (GFP).

18. The apparatus according to claim 12, wherein the adapter comprises:
a buffer, which is coupled to receive the Ethernet data frames from the receiver; and
a transmit controller, which is coupled to initiate concatenation of the Ethernet data frames to form the extended frame when a fill level of the buffer exceeds a predetermined watermark.

19. The apparatus according to claim 12, wherein the adapter comprises a counter, which is coupled to count a number of bytes placed in the extended data frame, and to terminate concatenation of the Ethernet data frames when the number reaches a predetermined limit.

20. Apparatus for communication, comprising:
a receiver, which is arranged to receive over a synchronous optical network link at a rate in excess of 9.5 Gb/s a flow of Ethernet data frames encapsulated using a Generic Framing Procedure (GFP);
an adapter, which is coupled to de-encapsulate and process the Ethernet data frames; and
a transmitter, which is arranged to receive the Ethernet data frames from the adapter and to transmit the flow over a 10 Gb/s Ethernet (10 GbE) link.

21. The apparatus according to claim 20, wherein the synchronous optical network link comprises at least one of a SONET OC-192 link and a SDH STM-64 link.

22. The apparatus according to claim 20, wherein the adapter is operative to process the Ethernet data frames so that all of the Ethernet data frames are transmitted over the 10 GbE link without frame loss irrespective of a size of the Ethernet data frames.

23. A network node, comprising:
first and second ring network interfaces, which are arranged to transmit and receive data over respective synchronous optical network links in a ring network at a rate in excess of 9.5 Gb/s; and
a 10 Gb/s Ethernet (10 GbE) link for transfer of the data between the first and second ring network interfaces.

24. The network node according to claim 23, wherein the data comprise a flow of Ethernet data frames encapsulated using a Generic Framing Procedure (GFP).
